(19) United States
(12) Patent Application Publication
(10) Pub. No.: US 2007/0102529 A1
(43) Pub. Date: May 10, 2007

(54) Information devices

(75) Inventors: Rosemary E. Sellew, Bend, OR (US); John C. Bohmker, Redmond, OR (US); Ricky L. Wright, Prineville, OR (US); Donald J. Rowden, Bend, OR (US)

Correspondence Address: KOLISCH HARTWELL, P.C., 200 PACIFIC BUILDING, 520 SW YAMHILL STREET, PORTLAND, OR, 97204, US

(73) Assignee: MacSema, Inc.

(21) Appl. No.: 11/595,686

(22) Filed: Nov. 8, 2006

Related U.S. Application Data
(60) Provisional application No. 60/735,010, filed on Nov. 8, 2005.

(51) Int. Cl. G06K 19/06

(52) U.S. Cl. 235/492

(57) ABSTRACT

Information devices including a casing, a circuit board installed in the casing, the circuiting having electrically conductive contact surfaces, and a memory device in electrical communication with the circuit board. In some examples, the information device includes a remotely accessible data device positioned on the casing or the circuit board. In some examples, the information device includes a symbology element disposed on the casing or the circuit board. In some examples, the information device includes a transceiver coupled to the casing or the circuit board.

### RELATED APPLICATIONS

This application claims priority under 35 U.S.C. § 119(e) to U.S. Provisional Application No. 60/735,010 filed on Nov. 8, 2005, the disclosure of which is incorporated herein by reference for all purposes.

### BACKGROUND

Information devices have long been used to associate information with a variety of objects. Conventional information devices include information stamped or printed on a relatively small size sheet of metal, plastic, or paper. Those information devices have been able to carry only a relatively small amount of information due to the small space available for printing the information. However, it may be desirable to provide more information than that which may be printed on the information device, or to periodically update the information that is available from the device.

For example, information relevant to maintenance applications may require considerable space and periodic updates. Information relevant to maintenance applications may include identification and configuration information for various types of machinery or equipment, such as motors, pumps, or aircraft components. Conventional information devices do not accommodate recording large amounts of information, and are not suited to modification once the information has been stamped or printed on the device. Additionally, printed or stamped information devices generally are accessible and reviewable by anybody, and thus are not suitable for use in maintaining confidentiality of information.

Information devices may be attached directly to objects. Although information may be stored electronically in any of a variety of memory modules, these devices generally have been configured for use in a computer, and thus have not been practical for use in physically associating information with objects. However, in recent years, with the decrease in size and cost of memory modules, it has become increasingly practical to physically associate information devices, including memory modules, with objects. Information devices have also been incorporated into fasteners, such as bolts, screws, or plugs.

Exemplary fasteners configured to employ information devices are described, for example, in U.S. Pat. No. 5,539,252 to Brorby, entitled FASTENER WITH ONBOARD MEMORY. Fasteners with onboard memory modules also are described in US Patent Publication No. US 2004/0135668 to Hoffer et al., entitled CLOSURE SYSTEM AND METHOD. U.S. Pat. No. 5,539,252 and US Patent Publication No. US 2004/0135668 are incorporated herein by this reference thereto.

Additional examples of information devices are described in the following references, which are each incorporated herein by reference for all purposes: U.S. Pat. Nos. 5,939,984, 6,046,676, 6,147,604, 6,356,197, 7,009,517, and 7,106,198; U.S Published Applications 20060009856, 20060208853, 20060097847, 20060113371, 20060133609, 20060145876, and 20060208089.

Although the aforementioned information devices having a memory module have proven suitable for use in associating information with objects, they have generally not been adapted to integrally include remotely accessible data devices. In addition, the information devices have not generally included means to broadcast their stored information.

### BRIEF DESCRIPTION OF THE DRAWINGS

FIG. 1 is a perspective view of an information device according to the present disclosure.

FIG. 2 is a side view of a cross section of the information device shown in FIG. 1.

FIG. 3 is a schematic view of the circuitry that may be used in the information device of FIG. 1.

FIG. 4 is a top view of an alternative example of an information device according to the present disclosure.

FIG. 5 is a top view of an alternative example of an information device according to the present disclosure.

FIG. 6 is a top view of an alternative example of an information device according to the present disclosure.

FIG. 7 is a top view of an alternative example of an information device according to the present disclosure.

FIG. 8 is a top view of an alternative example of an information device according to the present disclosure.

FIG. 9 is a top view of an external device interacting with the information device shown in FIG. 1.

FIG. 10 is a perspective view of an external device contacting the information device shown in FIG. 1 with a portion of the external device and the information device enlarged for clarity.

### DETAILED DESCRIPTION

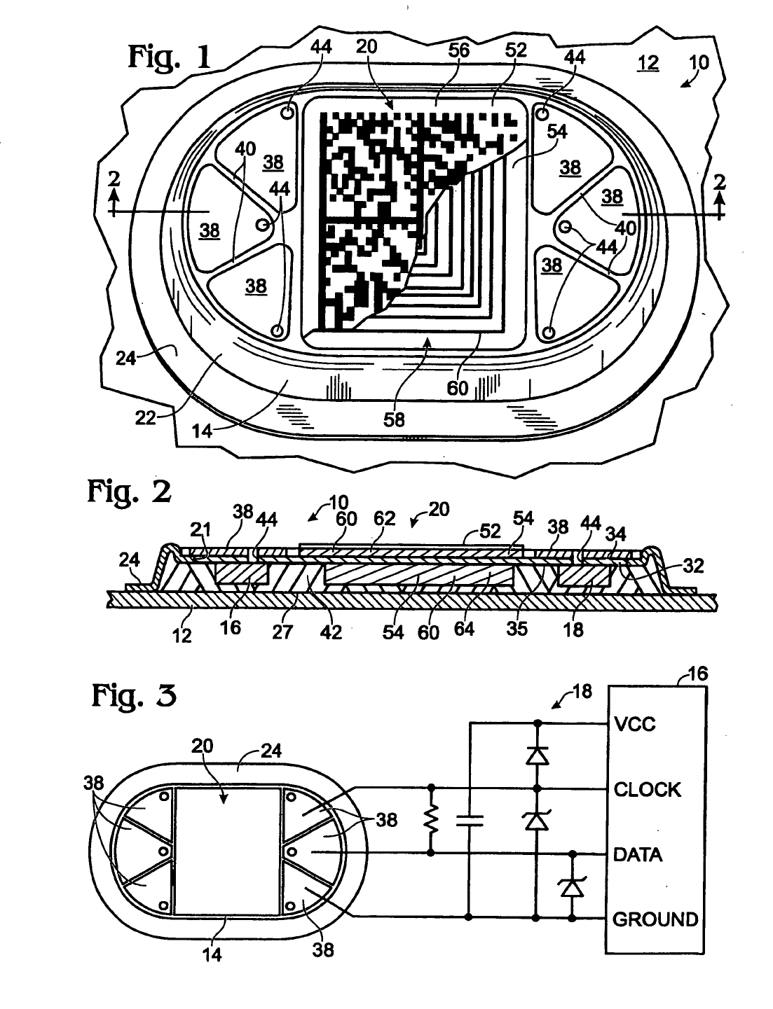

Referring initially to FIG. 1, an information device 10 for storing and retrieving data that can be selectively secured to an item 12 is described. Information device 10 may include a casing or housing 14, a memory device 16, a circuit 18, and a remotely accessible data device 20.

As shown in FIGS. 1 and 2, information device 10 typically includes casing or housing 14 providing structure and housing other components. Casing 14 may be a single-piece tubular metal casing, which defines a channel 21 between opposite casing ends. In some examples, casing 14 takes the form of an eyelet, such as a Stimpson A37 eyelet. Casing 14 may include a barrel 22 with a lower perimeter flange 24.

Information device 10 may include an attachment region 27 for fastening information device 10 to item 12. Attachment region 27 is typically located at an end of information device 10 distal from contact surfaces 38, such as on an underside of information device 10 as depicted in FIG. 2. An adhesive, a resilient snap ring, or other fastener may be used to fasten information device 10 to item 12.

Casing 14 may take any shape convenient for a given object 12 to which it is attached, such as machinery, avionics, containers, weapons, or equipment. Some examples of different form factors for casing 14 are shown in FIGS. 1 and 4-8. In some examples, casing 14 has a horizontal cross section and is generally circular, oblong, oval, square, or rectilinear. In an alternative example, shown in FIG. 5, casing 14 may have a curved end 28 and a straight end 30 opposite curved end 28. Such a configuration provides a smaller footprint than some of the other configurations depicted in FIGS. 1, 4, and 6-8.

Casing 14 may support any number of electronic or other devices, including (but not limited to) a memory device 16. Memory device 16 may include nonvolatile memory, volatile memory, or microprocessors. As should be apparent, memory device 16 may utilize any of a variety of memory technologies, including semiconductor memory, magnetic storage media, optical storage media, etc. Other devices that may be supported in casing 14 include clocks; sensors, such as temperature, vibration, or other sensors; or tracking devices; etc.

As used herein, “store” and “stored” means that information or data is at least temporarily placed in memory for retrieval later. Stored information may be temporarily stored or permanently stored. Temporarily stored information may be subsequently erased or overwritten with other information, while permanently stored information may not be subsequently erased or overwritten with other information. Information may be stored in any suitable format, with or without compression and/or encryption.

Information device 10 may include a circuit 18 electrically coupled to memory device 16 as depicted schematically in FIG. 3. Circuit 18 may be formed on a rigid, generally planar, printed circuit board 32 formed to fit somewhat closely within barrel 22. A first side 34 of the printed circuit board 32 may include a through-hole 44, which can be used to access information stored in memory device 16. As shown in FIG. 2, memory device 16 and circuitry 18 may electrically couple to a second side 35 of printed circuit board 32.

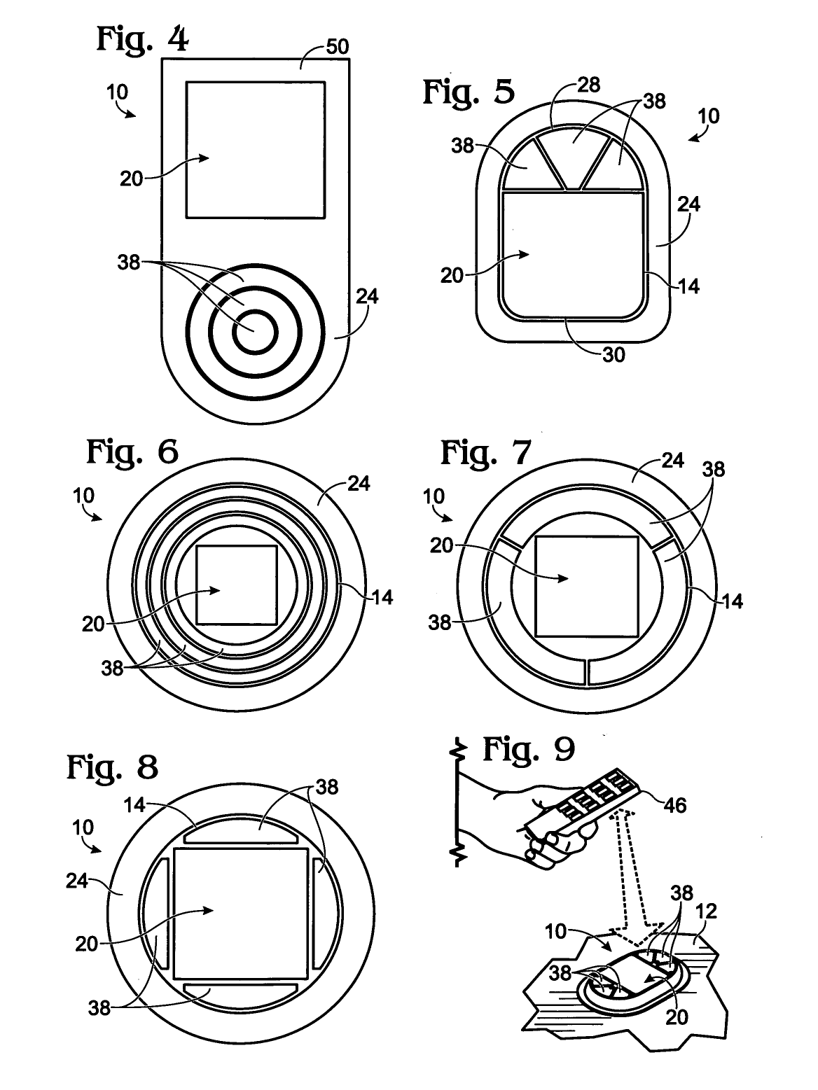

Printed circuit board 32 may include one or more electrically conductive contact surfaces 38. Contact surfaces 38 may be substantially planar and conform to a variety of form factors. For example, information device 10 depicted in FIG. 1 has six contact surfaces 38 separated into two groups of three. Information device 10 depicted in FIG. 4 includes three contact surfaces 38 in the shape of concentric circles. Contact surfaces 38 having shapes other than circles or having a different arrangement is contemplated to conform to different form factors, such as shown in FIGS. 5-8.

Contact surfaces 38 may be electrically isolated from each other, and from casing 14, to provide distinct electrical contact surfaces. Information device 10 may include nonconductive insulation boundaries 40 that facilitate electrical isolation of contact surfaces 38. One or more of insulating boundaries 40 may be defined by printed circuit board etching.

A plurality of through-holes 44 may be used to electrically connect contact surfaces 38 to components mounted on printed circuit board 32. Through-holes 44 may be arranged in a pattern to facilitate alignment of an external device 46 with contact surfaces 38. Any number of through holes 44 may be used.

Non-conductive potting material 42 is typically provided to maintain printed circuit board 32 of information device 10 in desired positions. Further, potting material 42 may seal, for example hermetically seal, components of information device 10 from environmental conditions, such as moisture. Potting material 42 may be added, for example while in a partially liquid or pourable state, to channel 21 after casing 14 has been press fit around printed circuit board 32. Potting material 42 added in this manner may fill in voids between components, such as memory device 16 and circuitry 18, electrically coupled to second side 35 of printed circuit board 32. Potting material 42 may subsequently harden and provide structure for the components, such as memory device 16 and circuitry 18, and seal them from the environment. In some examples, components of information device, such as a remotely accessible data device 20, may be disposed within potting material 42 when it is in a partially liquid or pourable state. Remotely accessible data device 20 added to potting material 42 may then remain imbedded in potting material 42 when it subsequently hardens.

Information device 10 may include one or more remotely accessible data devices 20 adapted to transfer data to external device 46 without contacting external device 46, such as shown in FIG. 9. Remotely accessible data device 20 may couple with or be applied to printed circuit board 32 in various positions such as between or adjacent one or more of contact surfaces 38 as depicted in FIGS. 1-3 and 5-9. Additionally or alternatively, remotely accessible data device 20 may couple with or be applied to flange 24. In other examples, such as shown in FIG. 4, information device 10 may include an extended flange tab 50 on which remotely accessible data device 20 may couple or be applied.

In some examples, such as shown in FIG. 1, information device 10 may include a first remotely accessible data device 52 and/or a second remotely accessible data device 54. First remotely accessible data device 52 may include a symbology element 56 that is optically readable by external device 46. For instance, symbology element 56 may be a machine readable barcode, such as a 2D Datamatrix barcode. External device 46 may read symbology element 56 by emitting light at symbology element 56 and processing the returning light reflected from symbology element 56.

Symbology element 56 may be applied to various parts of information device 10, such as printed circuit board 32, casing 14, and/or extended flange tab 50, in multiple ways. For example, symbology element 56 may be formed onto an adhesive label, which may then be applied to a desired portion of information device 10. Additionally or alternatively, symbology element 56 may be etched onto a metal insert, such as with laser etching, and the metal insert may be secured to a desired portion of information device 10. In some examples, symbology element 56 is directly etched onto a portion of information device 10, such as printed circuit board 32 or extended flange tab 50. Laser etching is one possible means of directly marking symbology element 56 onto a portion of information device 10. Additionally or alternatively, symbology element 56 may be added by chemical etching, chemical marking, mechanical engraving, dot peening, or printing, etc. Symbology element 56 may be applied by a manufacturer of information device 10 or may be applied by any user of information device 10 after it has been manufactured, which may provide certain functionality and flexibility for any such user.

Second remotely accessible data device 54 may include a transceiver 58 for transmitting and receiving data using an electromagnetic signal, such as depicted in FIG. 9. Electromagnetic signals may include radio frequency waves, infrared light, and/or magnetic fields. In some examples, transceiver 58 may be electrically connected to memory device 16 to facilitate data exchange between external device 46 and memory device 16.

Transceiver 58 may comprise a radio frequency identification tag 60. Radio frequency identification tag 60 may include an antenna 62 to transmit and/or receive a signal and an integrated circuit 64 to generate and/or process a signal. Radio frequency identification tag 60 may optionally include internal memory for storing data.

Radio frequency identification (“RFID”) tag 60 may be active, passive, or a combination of operating modes known as semi-active. An active RFID tag typically includes an internal power source to power signal generation by the integrated circuit. A passive RFID tag typically does not include an internal power supply, but instead is powered by the electrical current induced in antenna 62 by a carrier signal sent by external device 46. Integrated circuit 64 in a passive RFID tag may backscatter the carrier signal to transmit information using less power than an active RFID tag.

First and second remotely accessible data devices 52, 54 may couple with or be applied to printed circuit board 32 or other components of information device 10 in a variety of ways, including in layers. As illustrated in FIGS. 1 and 2, second remotely accessible data device 54 may be disposed in layered fashion between first remotely accessible data device 52 and printed circuit board 32. Alternative arrangements are possible, for instance, first remotely accessible data device 52 may couple with or be applied to first side 34 of printed circuit board 32 and second remotely accessible data device 54 may be positioned inside casing 14. However, both first and second remotely accessible data devices 52 and 54 may be positioned on first side 34 of printed circuit board 32. For example, second remotely accessible data device 54 may be coupled with or applied to first side 34 of printed surface board 32 adjacent to first remotely accessible data device 52 also coupled with or applied to first side 34 of printed circuit board 32.

In some examples, such as shown in FIG. 2, second remotely accessible data device 54 is a RFID tag 60 that couples with both first side 34 and second side 35 of printed circuit board 32. Antenna 62 of RFID tag 60 may couple with first side 34 of printed circuit board 32. In some examples, antenna 62 may be integrally formed in printed circuit board 32. Integrated circuit 64 of RFID tag 60 may couple with second side 35 of printed circuit board 32. In an alternative example, RFID tag 60 is positioned within potting material 42.

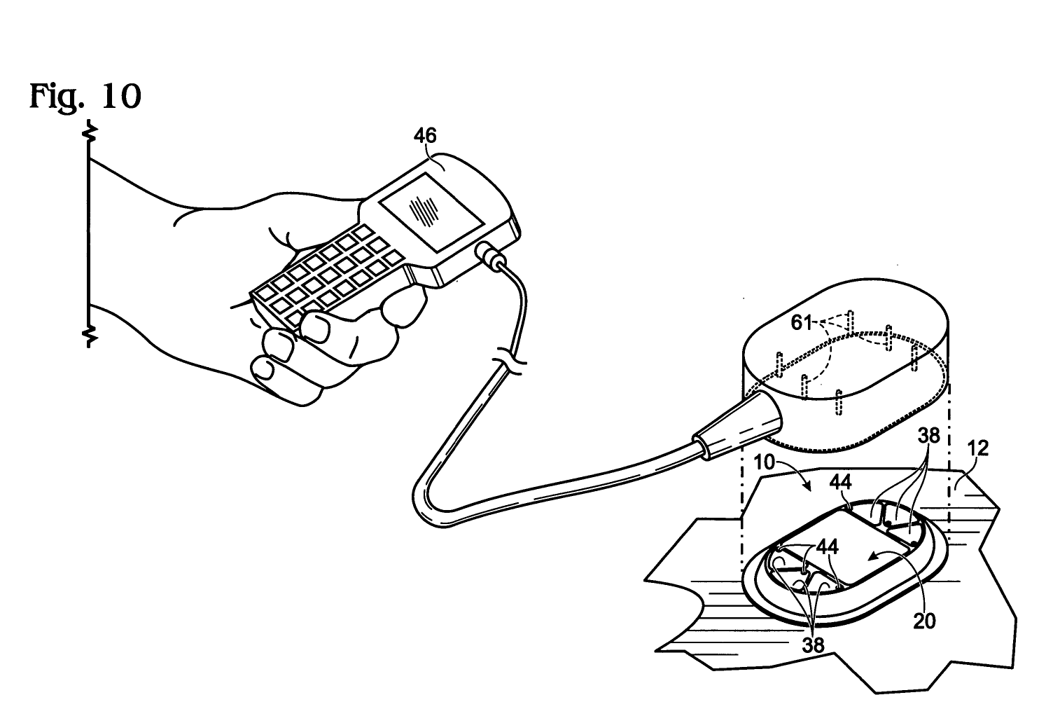

In some examples, external device 46 is configured to interface with information device 10 in multiple ways. For example, external device 46 may exchange information by contacting contact surfaces 38 (shown in FIG. 10), by optically reading information from symbology element 56, and/or by sending or receiving electromagnetic signals to or from second remotely accessible data device 54 (shown in FIG. 9).

As shown in FIG. 10, external device 46 may include pins 61 to contact the contact surfaces 38 of information device 10 so that it can read data from and/or write data to memory device 16. Contact between external device 46 and contact surfaces 38 in the desired orientation may allow external device 46 to exchange information with memory device 16.

Additionally or alternatively to contacting contact surfaces 38, external device 46 may read data from and/or write data to information device 10 remotely using a variety of wireless data transfer methods. For example, external device 46 may exchange information by optically reading information from symbology element 56. Further, external device 46 may transmit and receive electromagnetic signals with transceiver 58 of information device 10 to read and write data to memory device 16.

In some examples, external device 46 may include a microprocessor configured to read data from and write data to information device 10. External device 46 also may include a user interface for operating external device 46 and for programming information device 10. Additionally or alternatively, external device 46 may be a peripheral of another device configured to send data to and/or receive data from information device 10.

The same type or different types of information may be exchanged by each different data exchange method. For example, the same information can be exchanged by contacting external device 46 with memory device 16 via contact surfaces 38, reading information from first remotely accessible data device 52, or exchanging information with second remotely accessible data device 54. Thus, each method may provide redundancy in the event that any one information exchange method was not functioning properly. However, different types of information may be exchanged by the different information exchange methods as well. Differentiating the information exchanged with each method may simplify and speed information exchange in certain applications.

In operation, a user may store information on information device 10, secure information device 10 to item 12, and retrieve the stored information using external device 46. In addition, information can be modified, erased, rewritten, or supplemented as desired. Further, information device 10 can be selectively removed and attached to different items as needed.

Information may be stored in information device 10 in various ways. A user may contact external device 46 to contact surfaces 38 and input information into memory device 16. An additional or alternative method includes positioning a first remotely accessible data device 52, which typically includes stored information, on printed circuit board 32 or other component of information device 10. Moreover, a user may input information into memory device 16 by remotely sending information to information device 10 using electromagnetic signals. In some applications, information may be stored in information device 10 by the manufacturer of information device 10. In other applications, any user may store desired information in information device 10.

A user may retrieve information from information device 10 using external device 46 in numerous ways. Information may be retrieved by contacting external device 46 to contact surfaces 38. Another way to retrieve information involves remotely reading information from first remotely accessible data device 52 with external device 46. Yet another way to retrieve information includes receiving electromagnetic signals sent from second remotely accessible data device 54. One external device 46 may be configured to retrieve information using each of the multiple ways discussed, or, additionally or alternatively, separate devices may be used.

Information device 10 may be secured to item 12 by a variety of means. For example, information device 10 may be secured to item 12 with adhesives or by welding information device 10 to item 12. Additionally or alternatively, information device 10 may be snap fitted to item 12 with a resilient ring. Attaching information device 10 to item 12 may be selective and reversible, i.e. in some examples information device 10 may be secured and removed from item 12 multiple times.

While embodiments of an information device and methods of use thereof have been particularly shown and described, many variations may be made therein. This disclosure may include one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure. An appreciation of the availability or significance of claims not presently claimed may not be presently realized. Accordingly, the foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed.

Where the disclosure recites “a” or “a first” element or the equivalent thereof, such recitations include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

Inventions embodied in various combinations and subcombinations of features, functions, elements, and/or properties may be claimed through presentation of claims in a related application. Such claims, whether they are directed to different inventions or directed to the same invention, whether different, broader, narrower or equal in scope to the other claims, are also regarded as included within the subject matter of the present disclosure.

What is claimed is:

1. An information device for exchanging information with an external device and selective securement to an item, the information device comprising:
a unitary casing which defines a channel extending between opposite casing ends;
a circuit board having a first side and a second side, the first side defining a plurality of electrically conductive contact surfaces, the circuit board being installed within the casing adjacent one of the opposite casing ends such that the contact surfaces are substantially exposed;
a memory device mounted on the second side of the circuit board; and
a remotely accessible data device positioned on at least one of the casing and the circuit board.

2. The information device of claim 1, wherein the remotely accessible data device is a symbology element configured to exchange information optically.

3. The information device of claim 2, wherein the symbology element includes a machine readable barcode.

4. The information device of claim 1, wherein the remotely accessible data device is a transceiver configured to transmit and receive information using an electromagnetic signal.

5. The information device of claim 4, wherein the transceiver includes a radio frequency identification antenna.

6. The information device of claim 1, wherein the contact surfaces are concentrically arranged.

7. The information device of claim 1, wherein the memory device is selectively powered via the contact surfaces.

8. The information device of claim 1, wherein the remotely accessible data device is positioned within the channel.

9. The information device of claim 1, wherein the remotely accessible data device is coupled to the circuit board.

10. The information device of claim 1, wherein the remotely accessible data device is applied to the first side of the circuit board by at least one of printing, engraving, etching, and dot peening.

11. The information device of claim 1, wherein:
the casing includes an outwardly extending flange; and
the remotely accessible data device is positioned on the flange.

12. The information device of claim 1, wherein the remotely accessible data device includes:
a symbology element configured to exchange information optically, and
a transceiver configured to transmit and receive information using an electromagnetic signal.

13. The information device of claim 12, wherein the transceiver is disposed between the symbology element and the circuit board.

14. The information device of claim 1, further comprising a potting material in contact with the second side of the circuit board.

15. An information device for exchanging information with an external device and selective securement to an item, the information device comprising:
a casing which defines a channel extending between opposite casing ends;
a circuit board defining a plurality of substantially exposed electrically conductive contact surfaces, the circuit board being installed within the casing;
a memory device electrically coupled to the circuit board; and
a symbology element disposed on at least one of the casing and the circuit board.

16. The information device of claim 15, further comprising a radio frequency identification tag coupled to at least one of the casing and the circuit board and configured to transmit and receive information using an electromagnetic signal.

17. The information device of claim 16, wherein the symbology element is disposed on at least one of the casing and the circuit board on top of the radio frequency identification tag.

18. The information device of claim 15, wherein the symbology element is disposed on the circuit board adjacent the contact surfaces.

19. The information device of claim 15, wherein the contact surfaces are substantially exposed for periodic electrical access of the memory device.

20. An information device for exchanging information with an external device and selective securement to an item, the information device comprising:
a casing which defines a channel extending between opposite casing ends;
a circuit board defining a plurality of substantially exposed electrically conductive contact surfaces, the circuit board being installed within the casing;
a memory device electrically coupled to the circuit board; and
a transceiver coupled to at least one of the casing and the circuit board, the transceiver being configured to transmit and receive information using an electromagnetic signal.

21. The information device of claim 20, further comprising a symbology element which is disposed on at least one of the casing and the circuit board and configured to exchange information optically.

22. The information device of claim 21, wherein the symbology element is coupled to at least one of the casing and the circuit board on top of the transceiver.

23. The information device of claim 22, wherein the transceiver is coupled to the circuit board adjacent the contact surfaces.

24. The information device of claim 20, wherein the transceiver is a radio frequency identification tag.

25. The information device of claim 20, wherein the memory device includes non-volatile memory.
